(19) United States
(12) Patent Application Publication
(10) Pub. No.: US 2022/0256785 A1
(43) Pub. Date: Aug. 18, 2022

(54) ORNAMENTAL SEED AND PLANT GROWING SYSTEM

(71) Applicant: Michael E. Nipke, Wyoming, MI (US)

(72) Inventor: Michael E. Nipke, Wyoming, MI (US)

(21) Appl. No.: 17/671,956

(22) Filed: Feb. 15, 2022

Related U.S. Application Data
(60) Provisional application No. 63/149,469, filed on Feb. 15, 2021.

(51) Int. Cl. A01G 22/67; A01G 9/12; A47F 3/02; G06Q 20/18; G06Q 30/06

(52) U.S. Cl. CPC A01G 22/67; A01G 9/128; G06Q 30/0607; G06Q 20/18; A47F 3/02

(57) ABSTRACT

An ornamental seed and plant system includes a growing system with a growing pot that supports a potted plant and that has tie-down connectors for securing cordage to restrain a plant branch in a desired position to increase plant yield. A lid with additional tie-down connectors can be attached to the growing pot, and enables additional flexibility and support in securing plant branches in desired positions. The seed and plant system also includes a vending system having a vending machine that enables a consumer to purchase goods subject to authorization restrictions. The vending machines includes an identification reader that scans and interprets a form of consumer identification to either allow or prohibit the consumer from obtaining the goods. The vending machine may be located in a storage containment structure that also houses other horticultural products, including the growing system.

### CROSS REFERENCE TO RELATED APPLICATION

The present application claims priority of U.S. provisional application, Ser. No. 63/149,469 filed on Feb. 15, 2021, which is hereby incorporated herein by reference in its entirety.

### FIELD OF THE INVENTION

The present invention is directed to systems relating to improving the yield of a potted plant, and to a vending system for securely purchasing plants, plant byproducts, and other horticultural-related goods.

### BACKGROUND OF THE INVENTION

Many people grow and maintain plants in a growing pot, including plants that yield a desirable byproduct, such as seeds, fruits, buds, or vegetables. Depending on the characteristics of the plant sought to be grown, specialized growing equipment may be desired to optimize plant growth. Basic supplies and equipment for growing and maintaining plants, such as seeds, seedlings, pots, soil, and fertilizer, may be purchased at a store or other location, such as a plant nursery, a greenhouse, or a home and garden center. However, certain plants and plant byproducts are subject to restrictions and limitations under the law, and therefore may be inaccessible or not easily accessible in a consumer environment.

### SUMMARY OF THE INVENTION

The ornamental seed and plant system of the present invention includes a growing system for improving plant yield that includes a growing pot and a lid or tray that may be attached to the growing pot. The growing pot is configured to hold a potted plant and includes an upper rim having a series of tie-down connectors. The tray includes a tray surface with additional tie-down connectors that are located horizontally outboard of the tie-down connectors of the upper rim of the growing pot. The tie-down connectors are configured to secure one end of a length of cord or cordage used to restrain a branch of the plant in a desired position, such as horizontally, to increase the plant yield. The seed and plant system may also include a vending system having a vending machine or device that stores and enables a consumer—through an identify-verification process—to legally purchase various goods, such as plants and seeds, that may be subject to legal restrictions and limitations. The vending device contains an identification system that scans and interprets a form of the consumer's identification to permit or prohibit the consumer from obtaining goods contained inside or within a secure interior or cavity of the vending device. The vending device may also contain a printer to print a pickup receipt that is redeemable by a legal consumer to obtain goods, such as plants and seedlings, at a remote secure area. The vending device may be located in a retail display unit that is positioned in a desired location in a store, such as at the end of an isle or in view of a service counter.

According to one form of the invention, a growing system for improving plant yield includes a growing pot configured to hold and support a plant that is potted in soil. The growing pot has tie-down connectors that are configured to secure an end of a piece of cord that is used to restrain a branch of the plant in a desired position.

In one aspect, the growing pot further includes an upper rim. The tie-down connectors are defined by the upper rim in the form of pot through holes.

In another aspect, the growing system further includes a tray that may be selectively attached to the growing pot. The tray has a tray surface that extends horizontally outboard of the growing pot while the tray is attached to the growing pot. The tray surface defines an opening that the plant potted in the growing pot may protrude through while the tray is connected to the growing pot. The tray surface also includes additional tie-down connectors that are located horizontally outboard of the growing pot. The tie-down connectors located on the tray surface may be in the form of through holes, hooks, or a combination of through holes and hooks. The hooks may be integrally formed with the tray surface or may be selectively attachable at a desired location on the tray surface.

In yet another aspect, the tray includes a lower rim that fits complimentary with the upper rim of the growing pot. The lower rim may define through holes that align with the pot through holes while the lower rim is fitted complimentary to the upper rim. A plug can be inserted through the aligned through holes of the lower rim and the pot through holes to further secure the tray to the growing pot.

According to another form of the invention, a vending system allows a consumer of a legally-verified status to purchase horticultural goods—such as seeds, plants, and seedlings—by using a vending device. The vending device includes a secure cavity that houses goods, an identification system that can scan and interpret a form of the consumer's identification, a control panel that the consumer can use to select the type and quantity of goods they wish to purchase, a payment device configured to receive various forms of payment, and a dispensing unit configured to dispense a good from the secure cavity so the customer can obtain the good. After scanning and interpreting the form of the consumer's identification, the identification system either deems the consumer legal or illegal. If deemed illegal, the consumer is prohibited from obtaining a good. If deemed legal, the consumer may purchase and obtain a good.

In one aspect, the vending device further includes a printer that is configured to print a pickup receipt after the consumer has been deemed authorized, such as legally permitted, to purchase a product and has selected and paid for a good. The consumer may then obtain the good from a remote secure area by redeeming the pickup receipt at the remote secure area.

In another aspect, the secure cavity contains plant seeds and the remote secure area contains plants.

In yet another aspect, the vending device may be located in a storage containment structure that includes a shelf supported between a pair of vertical posts.

Thus, the ornamental seed and plant system of the present invention provides an effective way to improve plant yield and to obtain plant products, such as from a retail setting. A growing system includes a growing pot and a tray that may be attached to the growing pot. Both the growing pot and the tray provide a plurality of locations to which a piece of cordage may be secured to in order to restrain a plant branch in a desired position such that the yield of the plant is increased. A vending system includes a vending device that is able to discern the legal status of a consumer to selectively and securely dispense goods that may be subject to various legal restrictions. Specifically, the goods will only be dispensed to a consumer that has presented a form of identification was scanned, interpreted, and deemed legal by an identification system incorporated into the vending device. The vending device also includes a printer that can print a pickup receipt for an approved consumer to redeem to obtain goods contained in a remote secure area. The vending device may be located within a retail unit that sells other horticultural products, including the growing system.

These and other objects, advantages, purposes and features of the present invention will become apparent upon review of the following specification in conjunction with the drawings.

### BRIEF DESCRIPTION OF THE DRAWINGS

FIG. 1 is front elevation view of an ornamental growing pot containing a plant in accordance with the present invention;

FIG. 2 is a front elevation view of the growing pot of FIG. 1, shown with an attached lid and showing branches of the plant tied down thereto;

FIG. 3 is a front elevation view of the growing pot of FIG. 1, shown with support poles attached to the tray;

FIG. 4A is a front elevation view of a support pole extension attachment;

FIG. 4B is a front elevation view of a ground stake support pole;

FIG. 5 is a top plan view of the tray of FIG. 2;

FIG. 6 is a bottom plan view of the tray of FIG. 5;

FIG. 7 is a side elevation view of the tray of FIG. 5;

FIG. 8A is a perspective view of a plug configured to affix the tray to the growing pot;

FIG. 8B is a side elevation view of the plug of FIG. 8A;

FIG. 8C is an end elevation view of the plug of FIG. 8A;

FIG. 9 is a side elevation view of another tray in accordance with the present invention in which the tray has integrated tie-down hooks;

FIG. 10 is an enlarged view of the area designated X in FIG. 9;

FIG. 11 is a top plan view of another tray in accordance with the present invention in which the tray defines tie-down hook openings adapted to selectively receive and secure tie-down hooks;

FIG. 12 is an enlarged view of the area designated XII in FIG. 11, shown with a tie-down hook secured in the tie-down hook opening;

FIG. 13 is a cross sectional view taken along the line XIII-XIII in FIG. 12;

FIG. 14 is a front elevation view of a vending device in accordance with the present invention;

FIG. 15 is a flow chart representing a routine for purchasing a good or for receiving a pickup receipt to obtain a good through the use of the vending device of FIG. 14 in accordance with the present invention;

FIG. 16 is front elevation view of a storage containment structure that contains the vending device of FIG. 14, the growing system of FIG. 1, and other horticultural products in accordance with the present invention; and

FIG. 17 is a grow tent in accordance with the present invention.

### DETAILED DESCRIPTION OF THE PREFERRED EMBODIMENTS

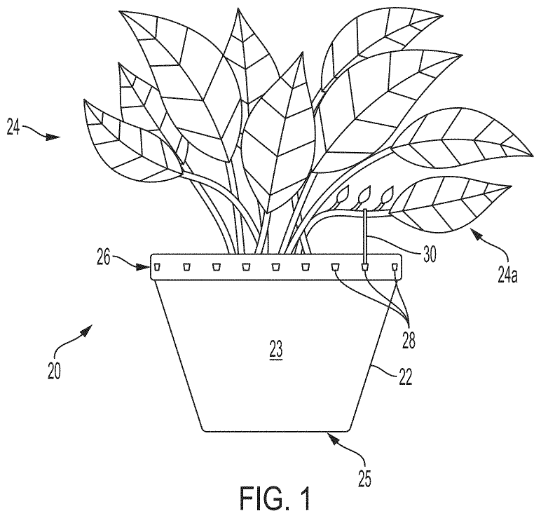

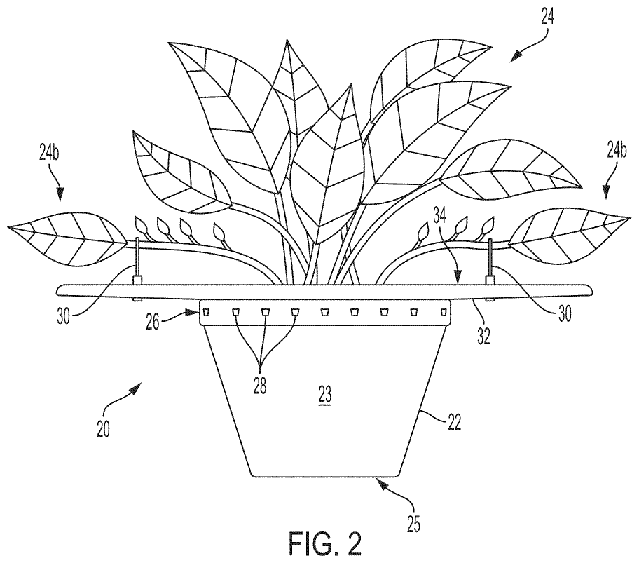

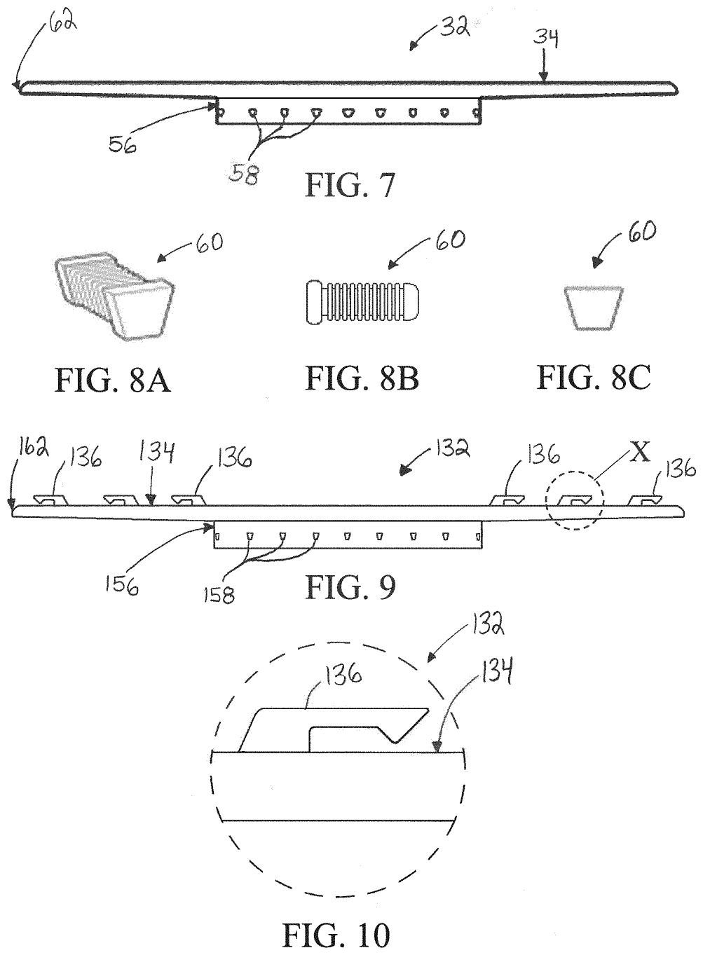

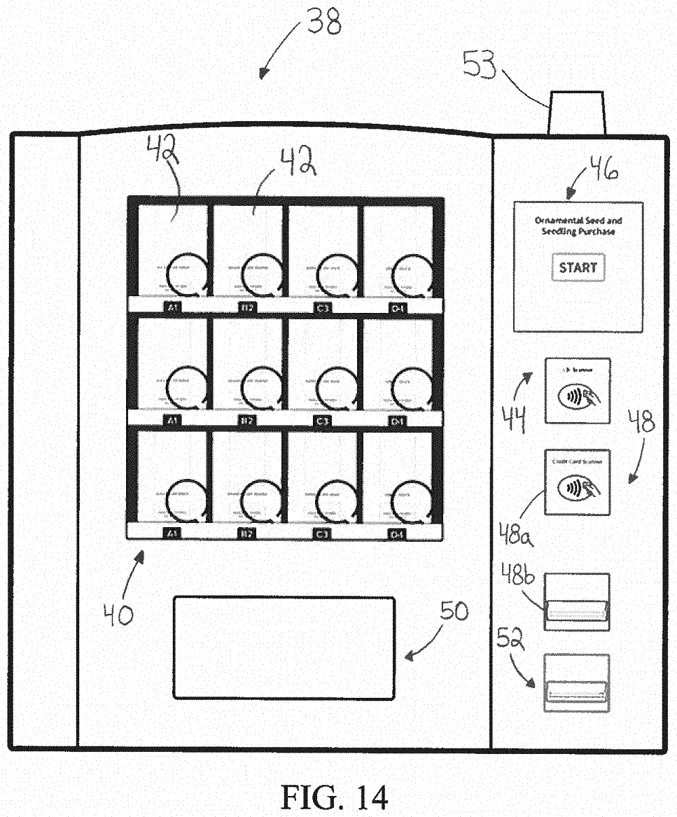

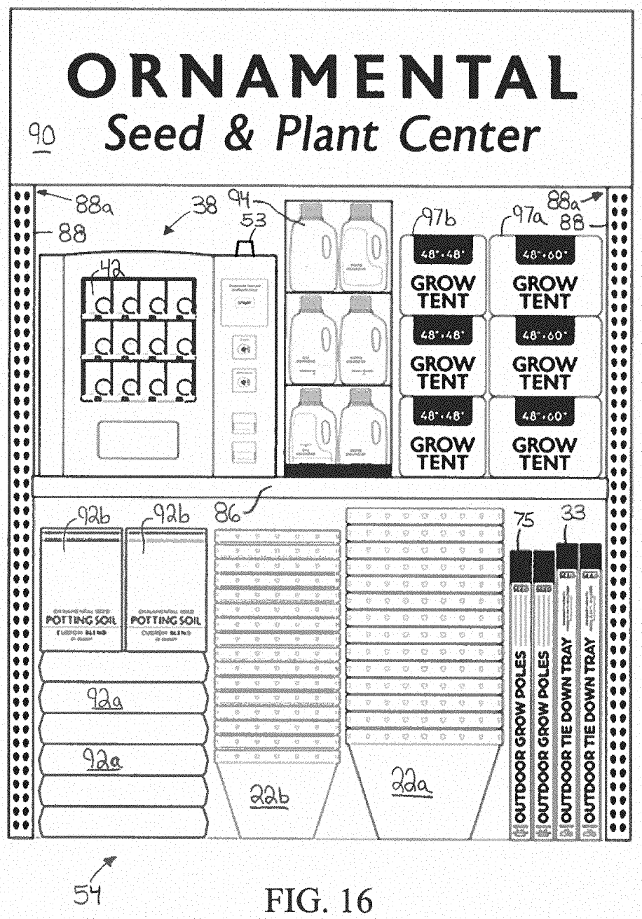

The present invention will now be described with reference to the accompanying figures, wherein the numbered elements in the following written description correspond to like-numbered elements in the figures. A growing system 20 is adapted to be used to improve the yield of a potted plant (FIG. 1). Growing system 20 includes a container or growing pot 22 to hold a plant 24 potted in soil or the like. Pot 22 has an upper rim 26 that defines a series of pot tie-down connectors in the form of pot through holes 28 which are configured to secure an end of a piece of cord or cordage 30, such as a zip tie, a wire, a rope, a string, or the like, that is used to restrain a portion of plant 24, such as a branch 24a, in a desired position. For example, restraining branch 24a in a pulled back or down orientation, such as in a generally horizontal position as shown, may improve the growth or yield or otherwise promote the growth or increase the harvestable plant matter of plant 24. As shown in FIGS. 2 and 5-7, growing system 20 may also include an upper lid that in the illustrated embodiment is configured as a tray 32 that may be optionally attached to pot 22. Tray 32 includes radially or outwardly extending portions, which in the illustrated embodiment are configured as projecting rim or surface 34 having tie-down connectors in the form of through holes 36 for use in restraining a branch, such as elongated branch 24b, or portions of plant 24 that are taller or extend horizontally outboard of pot 22 such that it would otherwise be more difficult to properly restrain these portions via pot through holes 28. Additionally, as shown in FIG. 14, a vending system includes a vending machine or device 38 having a secure interior or cavity 40 that houses horticultural goods such as seeds 42, an identification system 44 that scans an interprets a form of a consumer's identification, a control panel 46 that the consumer may use to select goods to purchase, a payment interface device 48 that the consumer may use to tender payment for the selected goods, and a dispenser or dispensing unit 50 that dispenses the selected and paid-for goods to the consumer. Vending device 38 also includes a printer 52 that prints a pickup receipt for goods the consumer has selected and paid for if the goods, such as plants and seedlings, are located in a remote secure area, such as a secure area of a retail store facility, as opposed to the goods being contained within vending machine 38. In this case, the consumer may redeem the pickup receipt, such as by submitting to an authorized employee at the remote secure area to obtain the selected and paid-for goods. The consumer may only obtain certain goods, such as packages of seeds 42, from vending device 38 or from a remote secure area if the consumer is determined to be properly authorized, such as by being of a particular legal status, which may be confirmed via identification system 44 scanning and interpreting a form of the consumer's identification. As shown in FIG. 16, vending device 38 may be located within a storage containment structure, or retail display unit 54, along with growing system 20 and various other horticultural goods offered for sale.

Referring now to the illustrated embodiment of FIGS. 1-3, pot 22 is adapted to support a plant potted in soil and/or other matter capable of sustaining and supporting plant life. Pot 22 includes a hollow, cone-shaped base portion 23 that has a flat bottom 25 to provide support and stability to growing system 20. In the illustrated embodiment, upper rim 26 is annular-shaped and defines multiple spaced-apart tie-down connectors in the form of pot through holes 28. String 30 can be looped around, tied to, or otherwise secured to or around branch 24a to restrain branch 24a. Once string 30 is secured to branch 24a, at least one end of string 30 may be secured directly or indirectly to a respective pot through hole 28 and then appropriately tensioned until branch 24a is in a desired position. For example, string 30 may be looped through a respective pot through hole 28 and then tied to itself after being appropriately tensioned to form a closed loop. Once string 30 is appropriately tensioned and secured between branch 24a and the respective pot through hole 28, branch 24a will remain in a desired position, which may be a horizontal position in which new plant stems, flowers, seeds, fruits, etc. may grow upwards from the branch 24a and towards a light source to thereby to optimize plant yield or other desirable plant traits. Many pieces of cordage can be similarly secured to the plurality pot through holes 28 to restrain multiple plant branches, thereby further increasing plant yield and/or other desired plant traits. Pot 22 may come in various sizes, including a larger pot 22a configured for outdoor use and that may be 22.5 inches in diameter and able to accommodate approximately 60 quarts of soil, and a smaller pot 22b configured for indoor use that may be 15.5 inches in diameter and able to accommodate approximately 20 quarts of soil. Alternatively sized pots and/or lids may be provided, including bigger or smaller and/or pots that are not round. It should be appreciated that a pot could have pot tie-downs that take alternative forms such as hook or other protrusion that a string could be attached to. Additionally, pot tie-downs could be defined or located elsewhere on a pot, such as on a base portion of a pot, while remaining within the scope of the present invention.

Referring now to FIGS. 2-7, tray 32 may optionally be attached to pot 22 to accommodate plants of different shapes and sizes, and to provide additional and/or optimal tie-down locations for cordage used to restrain plant branches. Lid 32 includes a lower flange 56 that defines a series of spaced-apart lower flange through holes 58, where in the illustrated embodiment flange 56 is annular so as to mate with the round opening of pot 22. Lid 32 can be attached to pot 22 by lowering lower flange 56 into upper rim 26 of pot 22. In this position, lower flange 56 fits complimentary to upper rim 26, such as in a press fit connection whereby the force of friction maintains the position of these components relative to one another. Additionally, the spacing between lower through holes 58 is such that when lower flange 56 is fitted into upper rim 26, at least some of lower holes 58 become aligned with at least some of pot through holes 28. When lower flange holes 58 are aligned with one or more pot through holes 28, a connector such as a plug 60 (FIGS. 8A-8C) may be inserted through the aligned lower flange holes 58 and pot through holes 28 to further secure tray 32 to pot 22. Securing tray 32 to pot 22 via plug 60 prevents tray 32 from being inadvertently lifted up and out of pot 22, such as may occur as plant 24 grows and matures. Tray 32 may be removed from pot 22 as desired, such as, for example, when plant matter is being harvested from plant 24. It should be appreciated that alternative configurations and/or methods could be used to attach a lid to a pot within the scope of the present invention. For example, a lid having a lower flange with external threads could be threaded into internal receiving threads on a pot. Alternatively, one or more fasteners or quarter-turn latching mechanism could be used to secure or lock a lid to a pot, or other forms of connectors may be employed.

In the illustrated embodiment, as noted, the attachable lid is configured as a generally flat tray 32 having a projecting rim 34 that extends outwardly or radially relative to pot 22. It should be appreciated, however, that alternatively configured and shaped lids may be employed that are selectively attachable to a pot and include outwardly extending portions. Referring again to the illustrated embodiment of FIGS. 2-7, projecting rim 34 and flange 56 are integrally connected, with projecting rim 34 including an outer edge 62 having ten sides 64 that are substantially equal in length. A series of outer corners 66 are present where two adjacent sides 64 meet. Tie-down connectors in the form of tray through holes 36 are located on opposing sides and along the length of a series of ribs 68a-j that extend from a respective corner 66 towards the center of projecting rim 34. Tray through holes 36 may be used in the same or similar fashion as pot through holes 28 to secure and tension cordage between a branch and tray through holes 36 to thereby restrain branch 24a in a desired position.

Ribs 68a-j subdivide tray surface 34 into segments 34a-j, and allow each segment 34a-j of tray surface 34 to bend and flex relative to one another, thereby reducing the influence that the bending or flexing of one segment 34a-j has on any other segment 34a-j. Specifically, the force resulting from cordage being secured and tensioned between a branch and a respective tray through hole 36 could produce bending stress in tray surface 34 that may cause deformation across tray surface 34, thereby changing the tension of other cordage used to restrain other plant branches. This may unintentionally result in plant branches being moved out of a desired position. For example, if segment 34a is pulled upward by cordage attached at rib 68a, another piece of cordage attached between adjacent rib 68b and a second branch may lose tension due to segment 34b and rib 68b being similarly pulled upward, thus resulting in the second branch raising or moving out of a desired position. In this example, ribs 68a-j allow segment 34a to rotate upward towards rib 68a at an angle from segment 34b, thus, keeping any strings attached along rib 68b in a substantially unchanged and properly tensioned position. It should be appreciated that alternative connectors and constructions may be employed with alternative outwardly projecting portions of a lid within the scope of the present invention, including radially protecting arms to which cordage may be attached.

Tray 32 has a center that defines a vertically-extending longitudinal axis that is shared with pot 22 while these components are attached. Tray surface 34 extends outwardly, such as horizontally or radially in the embodiment shown, further than pot 22 beyond the circumference of rim 26 of pot 22, such as extends horizontally outward relative to the aforementioned longitudinal axis. That is, outer side 34a of tray surface 34 is located at a horizontal distance from the longitudinal axis that is greater than that of any point on pot 22. This additional horizontal extension of tray surface 34 relative to pot 22 allows for tray through holes 36 to be located horizontally outboard of pot 22, thus enabling for the more supportive, secure, additional, and/or optimal attachment of string 30 to a branch, such as elongated branch 24b, that extends well past pot 22 in a horizontal direction. As a result, a grower has greater flexibility to position branches in various orientations to further increase plant yield. Additionally, a tray opening 70 is defined at the center of tray 32 to allow plant 24 to protrude through tray 32 while tray 32 is attached to pot 22.

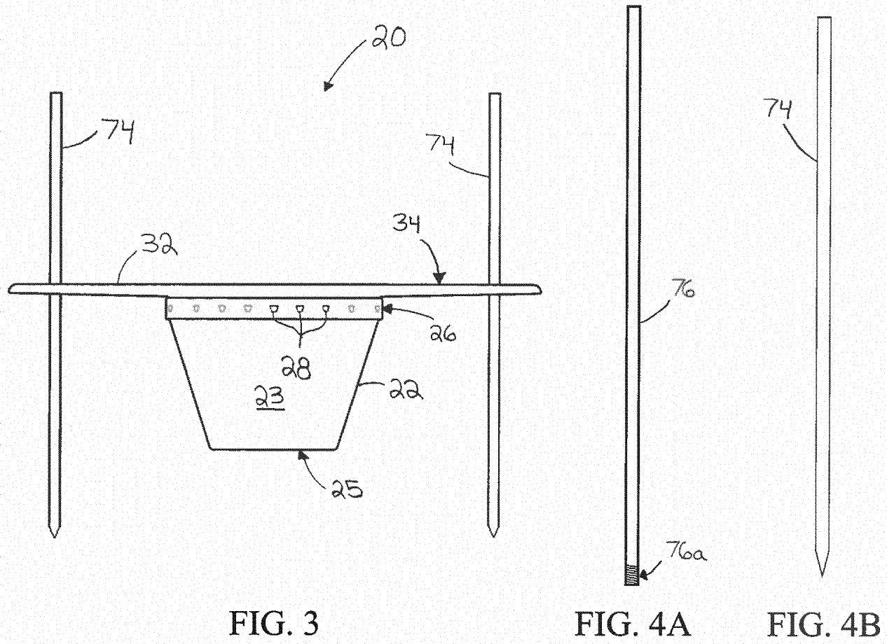

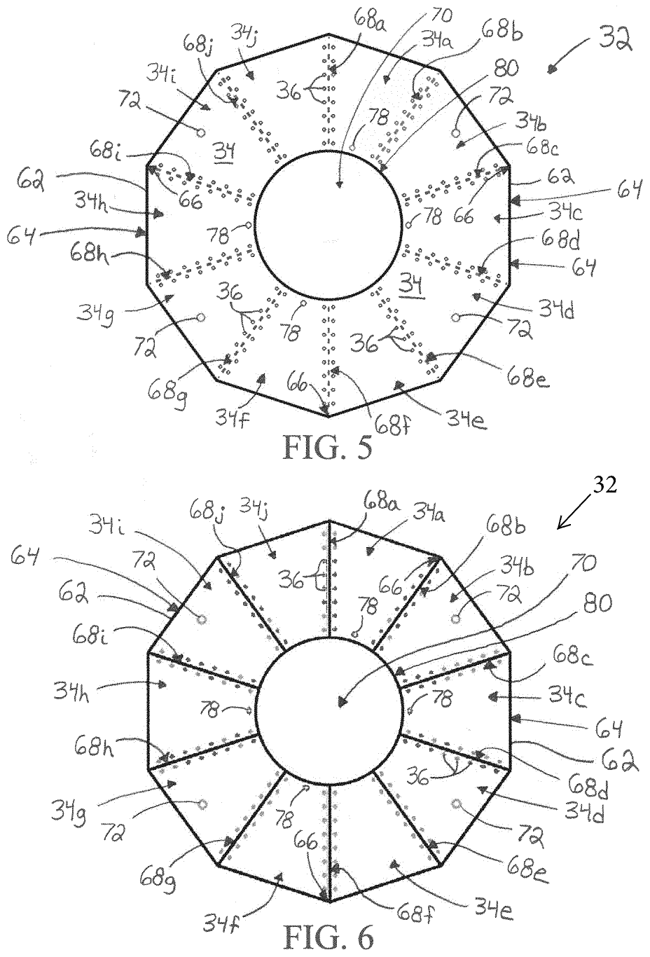

Referring specifically to FIGS. 5 and 6, tray 32 also defines other through holes serving other functions, including allowing tray 32 to accommodate additional equipment that may be beneficial in growing and/or maintaining a plant. For example, a series of support pole through holes 72 are defined near outer edge 62 of tray surface 34. Support pole through holes 72 are configured to receive a support pole, such as ground stake support pole 74 (FIG. 3) that provides additional support and stability to growing system 20, particularly for an outdoor growing system 20 that is subjected to windy conditions. An extension support pole 76 (FIG. 4A) has threads 76a that may be threaded into internal receiving threads (not shown) of ground stake support pole 74 (FIG. 4B) at the end opposite the point to extend the effective height of ground stake support pole 74. Still further, extension pole 76 may include internal threads at the end opposite threaded end 76a whereby extension poles 76 may be connected together. Having a support pole of an extended height may be beneficial for a number of reasons. For example, tray 32 may be secured to support poles 74, 76 at a location above that in which it could otherwise be secured to pot 22, thereby allowing for additional flexibility in restraining plant branches located at elevated locations. Additionally, cordage could be attached directly between support poles 74, 76 and elevated locations on a tall plant to provide additional support and stability to the tall plant, or to simply restrain elevated plant branches in a desired position. Tray surface 34 also defines irrigation through holes 78 near an inner side 80 of tray surface 34. Irrigation through holes 78 allow a hose or other conduit for providing water to plant 24 to pass through tray surface 34. Irrigation through holes 78 may be beneficial for accommodating a permanent or fixed irrigation line or system in which a hose could pass through irrigation hole 78 and be fixed in position above tray surface 34 to water plant 24 upon turning on the water supply.

Referring now to the illustrated embodiment of FIGS. 9 and 10, an alternative lid configured as tray 132 is shown that is similar to tray 32, with similar features of tray 132 relative to tray 32 being designated with like reference numbers, but with “100” added to each reference number of tray 132. Due to the similarities of tray 132 relative to tray 32, not all of the components and features of tray 132 are discussed herein. As shown, tray 132 has a tray surface 134 that includes tray tie-down connectors in the form of hooks 136 that are integrally formed with tray surface 134. A piece of cordage may be tied around or otherwise secured to a respective hook 136 to restrain a plant branch in a similar fashion as previously described with respect to branch 24a, string 30, and tray through hole 36. In addition, tray 136 includes a lower rim 156 defining lower rim holes 158, and additional features similar to tray 32 but not shown in FIGS. 9 and 10.

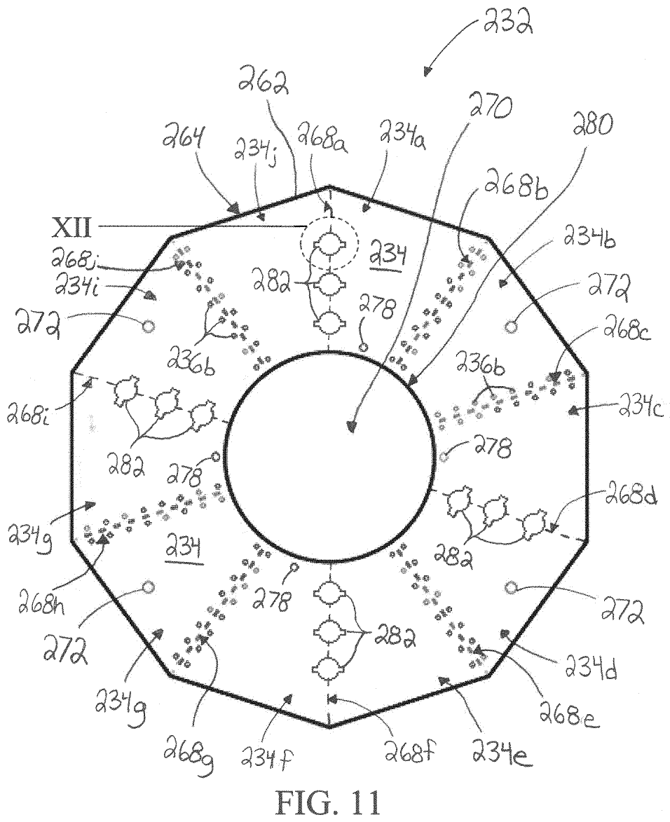

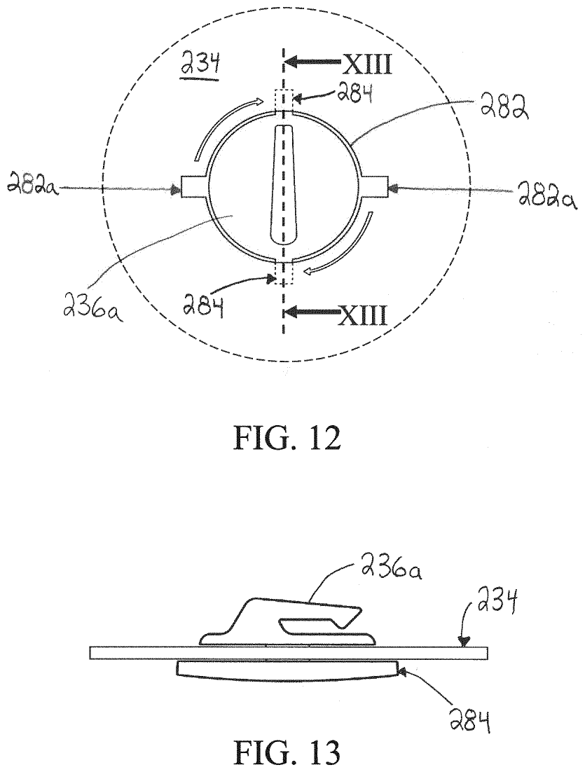

Referring now to the illustrated embodiment of FIGS. 11-13, another tray 232 is shown that is similar to tray 32, with similar features of tray 232 relative to tray 32 being designated with like reference numbers, but with “200” added to each reference number of tray 232. Due to the similarities of tray 232 relative to tray 32, not all of the components and features of tray 232 are discussed herein. As shown, tray 232 has a tray surface 234 that includes a series of hook openings 282 to which an attachable tray tie-down connector in the form of an attachable hook 236a may be selectively attached to. Similar to a quarter-turn latching mechanism, attachable hook 236a may be attached to tray surface 234 at a desired hook opening 282 by first inserting a latch portion 284 of attachable hook 236a through a hook slot 282a, then rotating adjustable hook 236a by approximately 90 degrees such that latch 284 is rotated underneath tray surface 234. In addition, tray 232 includes tray through holes 236b, tray segments 234, an outer side 262, sides 264, internal corners 266, ribs 268, a tray opening 270, support pole through holes 272, irrigation through holes 278, an inner side 280, and additional features similar to tray 32 but not shown in FIGS. 11-13.

It should be appreciated that various features and characteristics of a growing system may vary within the scope of the present invention. For example, tie down connectors could take the form of enclosed loops that are molded into or attached to a tray surface or pot. Additionally, a tray may be molded or otherwise integrally formed with a pot and/or support poles while remaining within the scope of the present invention.

Plants and seeds that may be grown or otherwise used in growing system 20 may be purchased via a vending system. The vending system can also be used to purchase restricted plants and plant byproducts that may be subject to certain taxes, laws, or regulations that impose certain limitations and restrictions how the goods are taxed, grown, distributed, used, stored, handled, to whom the goods may be sold to or purchased by, etc. For example, the cannabis genus of flowering plants and the various byproducts of these plants are subject to certain taxes and legal restrictions or prohibitions that vary by jurisdiction. Currently, some jurisdictions allow for the limited and/or restricted use and sale of cannabis plants and related byproducts of cannabis plants. The vending system described below seeks to provide a sales system that can satisfy the legal requirements necessary to at least store and sell certain restricted goods, such as restricted plants and plant byproducts, in certain jurisdictions.

Referring now to the illustrated embodiment of FIG. 14, the vending system includes vending machine or device 38 which incorporates a secure interior or cavity 40 to house products, such as restricted goods, including packages of seeds 42. Unauthorized access to contents stored within secure cavity 40 may be prevented in various ways. For example, secure cavity 40 is made from resilient and durable materials that are assembled in such a way to ensure that secure cavity 40 is not easily tampered with, damaged, or otherwise able to be bypassed to gain unauthorized access to contents stored within secure cavity 40. Thus, only an authorized user, such as an employee with proper clearance to restock vending device 38, is able to access secure cavity 40. Additionally, goods that may not be easily stored within secure cavity 40, such as plants and seedlings, may be stored at a remote secure area, such as an area that is cordoned off from the general public and/or kept under guard, watch, or surveilled by authorized personnel and/or includes security devices such as cameras and alarm systems. The remote secure area may also be located in an appropriate environment to sustain plant-life, such as in a plant nursery, a home and garden center in a brick and mortar store, a greenhouse, or a greenhouse-like area, in which the plants are cared for by authorized personnel.

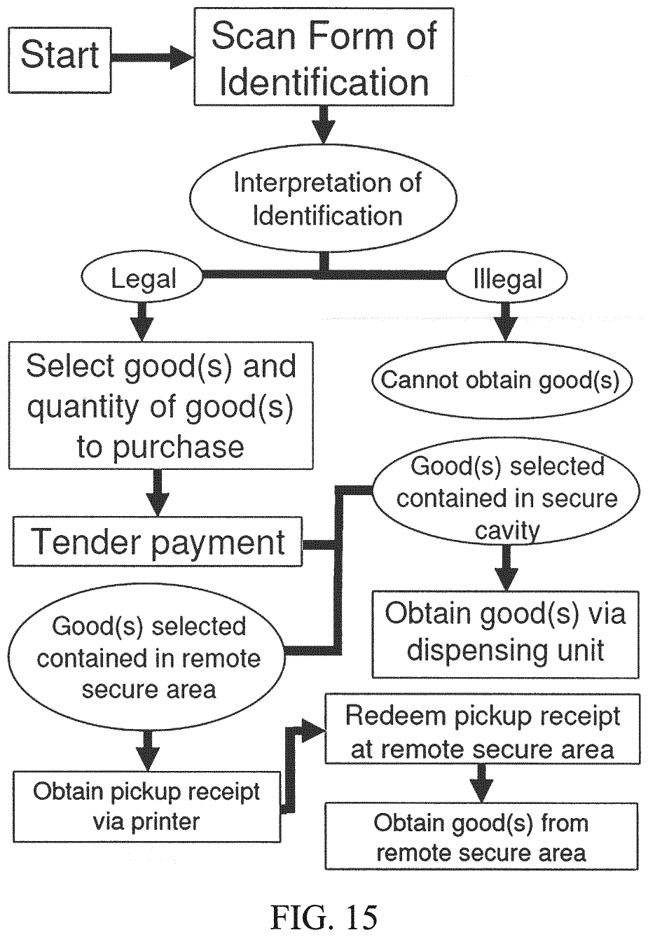

An authorized consumer may purchase and obtain one or more of the goods stored within secure cavity 40 or the remote secure area via a consumer identity-verifying process, such as, for example, the process represented in FIG. 15. As shown in the exemplary process represented in FIG. 15, a consumer seeking to purchase a good from vending device 38 or the remote secure area may begin by pressing an icon or button on control panel 46, such as a “start” icon. In the illustrated embodiment, control panel 46 is a touchscreen. However, control panel 46 may also take other forms including that of a physical keypad located below a screen or touchscreen. Control panel 46 and/or identification system 44 may then prompt the consumer to present one or more forms of identification or other necessary documentation required by law to purchase restricted goods to be scanned and interpreted by identification system 44. The consumer may then insert, tap, or otherwise position or maneuver their form of identification, such as a driver's license or identity card, relative to identification scanner 44 such that it is scanned or otherwise read. After the identification has been scanned, identification system 44 interprets the identification which may accomplished, for example, by first identifying the consumer based on information from the scanned identification, and then comparing the identified consumer against a database to ensure the identified consumer is of a legal status to be able purchase the restricted goods within secure cavity 40 or the remote secure area. The database may be located within vending device 38 or a remote location that can be accessed via an internet connection or otherwise. Additional information may also be obtained to further enhance the consumer identity verification process, including biometric data harnessed from a finger print scan and/or a facial recognition scan. After the form of the consumer's identification has been scanned and interpreted, identification system 44 deems the consumer to be of either a legal or illegal status to purchase and obtain the restricted goods from secure cavity 40 or the remote secure area. If the consumer is deemed of an illegal status, then further action to purchase or obtain the restricted goods is prohibited.

If the consumer is deemed to be authorized to purchase a product, such as being of a legal age or other status, then the consumer may use control panel 46 to select the type and quantity of goods desired for purchase. To make a more informed decision before purchasing any goods, the consumer may also interact with control panel 46 to read information related to the goods, such as a description of a specific good and pricing information related to a specific good, where panel 46 may be configured to present product information.

After selecting the type and quantity of goods to be purchased, the consumer will be prompted by control panel 46 and/or payment device 48 to tender payment for the goods selected. Payment device 48 includes a scanning device 48a that is configured to accept numerous forms and methods of payment, such as payment done by tapping or scanning credit cards or debit cards, or payments from a portable electronic device, such as a cell phone. Payment device 48 also includes a physical payment device 48b that is configured to accept other forms and methods of payment, such as payment done by swiping or inserting a credit card or debit card, or payment done by inserting paper bills and/or coins.

After the consumer has tendered payment in the appropriate amount for the goods selected, the consumer may obtain the goods. Any good selected from secure cavity 40 may be automatically dispensed from secure cavity 40 to dispensing unit 50 at this point, such as seeds in packages. Once dispensed, the consumer may obtain the good from dispensing unit 50. A consumer may alternatively purchase plants, such as grown plants or seedlings, via vending machine 38, where such plants are not contained within the interior of vending machine 38, but instead may be retained within a secure area, such as of a retail facility. If any goods selected are located in the remote secure area, printer 52 will print a pickup receipt evidencing, for example, the specific goods selected, the quantity of the goods selected, and the consumer that purchased these goods. The pickup receipt may then retrieved by the consumer from printer 52 and redeemed at the remote secure area to obtain the goods specified on the pickup receipt from the remote secure area. For example, if the consumer selected and paid for two ornamental plants contained in the remote secure area, printer 52 could print a pickup receipt evidencing that this specific consumer selected and paid for two ornamental plants. The consumer may then redeem the pickup receipt to obtain the ornamental plants, such as by showing or exchanging the pickup receipt with authorized personnel, or through an automated process such as using a scanner that is able to scan the pickup receipt and then distribute the ornamental plants.

Vending machine 38 may be configured to operate in various manners, including wirelessly, hardwired, pre-programmed, and/or programmable via a laptop, or the like. For example, the verification of whether or not a purchaser is authorized to purchase a product may be performed internally of vending machine 38, or it may wirelessly access a remote database. The software and/or firmware of vending device 38 may be initially programmed or later updated through an external electronic device, such as a computer, that connects to vending device 38 wireles sly, such as through a Wi-Fi connection via a wireless antennae 53, which in the illustrated embodiment is located on top of the vending machine 38 and has a conical shape and is approximately 1.5 inches in diameter and 3 inches tall, or through a data communication port, such as a USB port. In this way, the software and various settings of vending device 38 may be adjusted, for example, to improve the consumer experience when interacting with vending device 38, to update product pricing and product information, and to allow for the various procedures and steps performed or required by vending device 38 that enable a consumer to purchase a good to be updated to remain current relative to changing legal requirements. Furthermore, vending device 38 can collect, store, and transmit information related to point of sale data, inventory data, the type and quantity of goods purchased, when and where the goods were purchased, by whom the goods were purchased, and additional transactional data or data transaction sets that may be part of or otherwise make up an electronic data interchange (EDI) or other dataset, for example, to comply with potential regulations that may require collection of this information. Transmission of this data could occur via a wireless transmission from communicator 53 to an external database or by using a hardwired connection to another electronic device, such as a server or computer. Collection of this data may enable for the more efficient or complete collection of data necessary for a government entity, such as a state or federal tax agency, to collect tax revenue from a private entity, such as the retailer whose location or storefront the vending machine 38 is located in. In this way, avoidance of applicable taxes may be reduced with regard to restricted goods or goods subject to additional regulatory scrutiny and/or specific or elevated taxes.

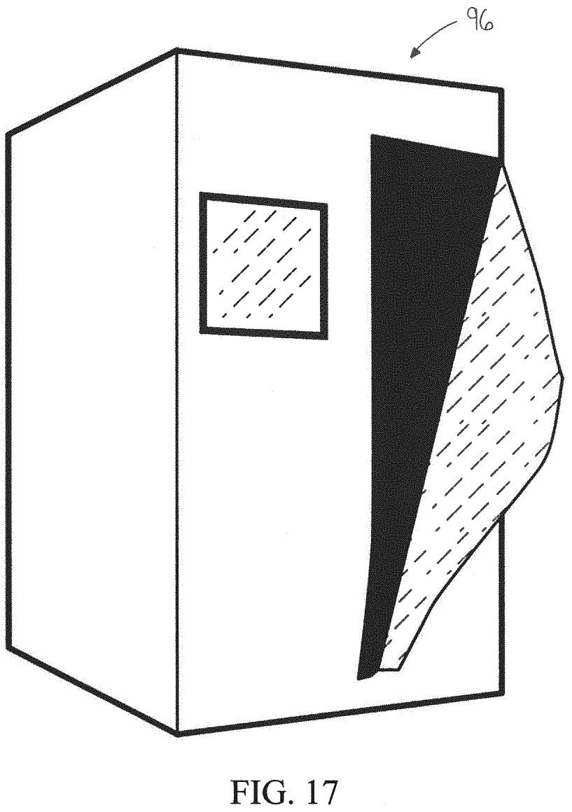

Referring now to FIG. 16, a storage containment structure or retail display unit 54 comprises a rack comprising a vertically-adjustable shelf 86 supported by four vertical posts 88 (only two of which are visible) and provides a consumer with access to both restricted and unrestricted goods of growing system 20, including via vending device 38, described above. An upper portion 88a of vertical posts 88 are configured to receive and secure a sign 90 to provide consumers with a visual indication of the goods and/or brand name of goods being sold at retail unit 54. Goods accessible for purchase at retail unit 54 include pot 22, which may come in the form of outdoor pot 22a or indoor pot 22b, tray 32 (shown in tray packaging 33 in FIG. 16), support poles 74, 76 (shown in pole packaging 75 in FIG. 15), large bags of soil 92a, small bags of soil 92b, fertilizer, water enhancer 94, and growing tents 96 of a large size 96a, which measures 48 inches by 60 inches when assembled, and a small size 96b, which measures 48 inches by 48 inches when assembled (shown in large tent packaging 97a and small tent packaging 97b in FIG. 16 and fully assembled in FIG. 17). The amount of soil contained in each bag of soil 92a, 92b is specific to fill a respective pot 22a, 22b with a proper or ideal amount of soil. That is, large bags of soil 92a each contain 60 quarts of soil to optimally fill each outdoor pot 22a, where each outdoor pot 22a has a diameter of 21.5 inches. Similarly, small bags of soil 92b each contain 20 quarts of soil to optimally fill each indoor pot 22b, where each indoor pot has a diameter of 15.5 inches. Additionally, grow pots 22a, 22b and tents 96a, 96b are specifically sized and/or dimensioned relative to one another to maximize the number of grow pots 22a, 22b that may be positioned and used within tents 96a, 96b to grow plants. For example, the size and/or dimensions of the 15.5 inch indoor pot 22b is optimized relative to both the 48 inch by 60 inch large tent 96a or the 48 inch by 48 inch small tent 96b to allow for a maximum number of indoor pots 22b to be used for growing plants within the volume of either tent 96a, 96b. Furthermore, each pole packaging 75 is sized to fit 12 poles, which include four ground stake support poles 74 that are approximately three feet long, and eight extension support poles 76 that are also approximately three feet long. The shape and size of retail unit 54 allow it to be placed as an isle end cap (at the end of an isle in a store) or as a standalone structure in a brick and mortar store, including in a retail store, a grocery store, a hardware store, a home and garden store, a plant nursery, or a greenhouse. In the illustrated embodiment, retail display unit 54 is approximately 96 inches wide, 96 inches tall, and 42 inches deep. These dimensions are such that the products and product packaging, including the products and packaging dimensions described above that are sized and designed to be purchased together and optimally used together, as well as the dimensions of vending machine 38, fit ideally or optimally within retail unit 54, where retail unit 54 is also sized to fit on a standard isle end cap, as noted above. Additionally, retail unit 54 can be placed in an area such as near a service counter in a store in order to comply with possible laws and/or regulations that may require retail unit 54 or the products sold in retail unit 54 to be visible by or located near authorized personnel. Thus, retail unit 54 provides a spatially-efficient retail area that can house, contain, display, store, and/or offer for sale both restricted and unrestricted goods of a certain category cluster, or of related or otherwise complimentary goods, for consumer purchase.

Accordingly, the ornamental seed and plant system of the present invention provides an effective way to increase the yield of a plant and to legally purchase seeds, plants, and other goods related to growing plants that may have legal restrictions or limitations. A pot 20 has an upper rim 26 defining pot through holes 28. A string 30 connected to pot through holes 28 can be secured to a branch 24a of a plant 24 and tensioned to restrain the branch in a desired position, such as a horizontal position, to increase plant yield. A tray 32 having a tray surface 34 defining tray through holes 36 allow for string 30 to restrain a plant branch from additional locations for more support. A vending device 38 includes a control panel 46 that a consumer may use to select one or more restricted goods contained within a secure cavity 40. In order to obtain the goods, the consumer must first present a valid identification to be scanned and interpreted by identification system 44. If identification system 44 deems the identified consumer of a legal standing to purchase and obtain the restricted goods, then the consumer can either pick up the goods from a dispensing unit 50 that is incorporated into vending device 38, or obtain a pickup receipt printed by a printer 52 to be redeemed at a remote secure area where the restricted goods may be obtained. Furthermore, a retail unit may be placed at a desired location, such as in a store, and may contain vending device 38 as well as growing system 20 and various other products.

Changes and modifications in the specifically described embodiments may be carried out without departing from the principles of the present invention, which is intended to be limited only by the scope of the appended claims, as interpreted according to the principles of patent law including the doctrine of equivalents.

The embodiments of the invention in which an exclusive property or privilege is claimed are defined as follows:

1. A growing system for a potted plant comprising:
a pot comprising a pot tie-down connecter;
wherein said pot is configured to hold soil and a plant that is potted in the soil; and
wherein said pot tie-down connector is configured to receive a piece of cordage to restrain a branch of the plant to the pot.

2. The growing system of claim 1, wherein said pot further comprises a rim, and wherein said pot tie-down connector comprises a pot through hole in said rim.

3. The growing system of claim 1, further comprising a lid that may be selectively engaged with said pot, said lid comprising:
an extension portion that extends outwardly of said pot when said lid is attached to said pot;
a lid opening extending through said lid; and
a lid tie-down connector disposed on said extension portion at a location that is outboard of said pot while said lid is attached to said pot;
wherein said lid opening is configured to enable a plant to protrude there through when said lid is engaged with said pot; and
wherein said lid tie-down connector is configured to receive a piece of cordage to restrain a branch of the plant to the lid.

4. The growing system of claim 3, wherein said lid comprises a plurality of lid tie-down connectors in the form of a plurality of through holes extending through said lid.

5. The growing system of claim 3, wherein said lid further comprises a plurality of lid tie-down connectors in the form of a plurality of hooks.

6. The growing system of claim 5, wherein said lid further comprises a plurality of lid through holes, and wherein each said lid through hole is configured to receive a piece of cordage to restrain a branch of the plant to the lid.

7. The growing system of claim 3, wherein said lid further comprises a flange that fits complimentary with said pot to engage said lid with said pot.

8. The growing system of claim 7, further comprising a lid connector, wherein said flange includes a flange hole, and wherein said pot tie-down connector comprises a pot through hole that is aligned with said flange hole when said lid is attached to said pot, and wherein said lid connector is configured to be inserted through said flange hole and said pot through hole when said flange hole and said pot through hole are aligned with one another.

9. The growing system of claim 7, wherein said lid tie-down connector comprises a lid through hole in said extension portion of said lid.

10. The growing system of claim 7, wherein said lid tie-down connector comprises a hook.

11. The growing system of claim 10, wherein said hook may be selectively attached to said extension portion of said lid at a plurality of locations.

12. The growing system of claim 11, wherein said extension portion of said lid includes a lid through hole configured to receive a piece of cordage to restrain a branch of the plant.

13. The growing system of claim 12, further comprising a support pole configured to be secured to an area of ground, and wherein said extension portion of said lid further defines a support pole through hole configured to receive said support pole.

14. A vending system for securely purchasing horticultural goods comprising:
a vending machine comprising:
a secure interior containing a good;
an identification reader system;
a control panel;
a payment interface configured to receive payments; and
a dispenser configured to dispense the good from said secure interior;
wherein said identification reader system is operable to scan, interpret, and deem an identification form of a consumer to be authorized to purchase goods or unauthorized to purchase goods;
wherein when the interpretation of the identification form is deemed to authorize purchase of the good:
(A) said control panel is operable to enable selection of the good for purchase contained within said secure interior;
(B) said payment interface is operable to enable receipt of payment for the good selected for purchase; and
(C) said dispenser is operable to dispense the selected and paid for good from said secure interior; and
wherein when the interpretation of the identification form is deemed unauthorized to purchase the goods, the vending machine is not operable to dispense goods from said secure interior.

15. The vending system of claim 14, further comprising a remote secure area containing a second good, and wherein said vending machine further comprises a printer;
wherein when the interpretation of the identification form is deemed to authorize purchase of goods:
(A)(i) said control panel is operable to enable selection of the second good for purchase;
(B)(i) said payment interface is operable to receipt of payment for the second good selected for purchase; and
(C)(i) said printer is operable to print a pickup receipt for a consumer associated with the second good; and
wherein the second good is retained within said remote secure area and wherein the pickup receipt is exchangeable for the second good at said remote secure area, and wherein when the interpretation of the identification form is deemed to be unauthorized to purchase the second good, the vending machine is not operable to print a pickup receipt for the second good.

16. The vending system of claim 15, wherein said secure interior contains plant seeds, and wherein said remote secure area contains plants.

17. The vending system of claim 16, further comprising a storage containment structure comprising a rack, wherein said rack contains said vending machine, wherein said storage containment structure contains both restricted and unrestricted goods, wherein said restricted goods comprise the plant seeds contained in said secure interior, and wherein said unrestricted goods comprise at least a pot configured to hold a potted plant, a lid configured to be selectively engaged with said pot, and a bag of potting soil.

18. A growing system for potted plants comprising:
a pot comprising an rim defining a plurality of pot through holes;
a lid configured to be selectively engaged with said pot, said lid comprising:
an extension portion that extends outwardly of said pot when said lid is attached to said pot;
a lid opening extending through said lid; and
a plurality of lid through holes in said extension portion at locations that are outboard of said pot when said lid is attached to said pot;
wherein said pot is configured to hold soil and a plant that is potted in the soil;
wherein said pot through holes are configured to receive a piece of cordage to restrain a branch of the plant to said pot;
wherein said lid opening is configured to enable a plant to protrude there through when said lid is engaged with said pot; and
wherein said lid through holes are configured to receive a piece of cordage to restrain a branch of the plant.

19. The growing system of claim 18, wherein said lid further comprises a flange that fits complimentary with said rim to engage said lid with said pot.

20. The growing system of claim 19, wherein said extension portion of said lid further comprises a plurality of hooks that are each configured to receive a piece of cordage to restrain a branch of the plant.
